(19) United States
(12) Patent Application Publication
(10) Pub. No.: US 2020/0140314 A1
(43) Pub. Date: May 7, 2020

(54) METHOD FOR MANUFACTURING ALKALI-FREE GLASS SUBSTRATE

(71) Applicant: NIPPON ELECTRIC GLASS CO., LTD., Otsu-shi, Shiga (JP)

(72) Inventors: Masahiro TOMAMOTO, Otsu-shi, Shiga (JP); Hitoshi KANAYA, Otsu-shi, Shiga (JP); Toru HASEGAWA, Otsu-shi, Shiga (JP); Toru SAKURABAYASHI, Otsu-shi, Shiga (JP)

(73) Assignee: NIPPON ELECTRIC GLASS CO., LTD., Otsu-shi, Shiga (JP)

(21) Appl. No.: 16/473,364

(22) PCT Filed: Dec. 7, 2017
(86) PCT No.: PCT/JP2017/044085

§ 371 Date: Jun. 25, 2019

(30) Foreign Application Priority Data
Dec. 26, 2016 (JP) 2016-251134
Jun. 6, 2017 (JP) 2017-111419

(51) Int. Cl. C03B 17/06; C03B 5/027; C03C 3/087

(52) U.S. Cl. CPC C03B 17/064; C03C 3/087; C03B 5/027

(57) ABSTRACT

A method for manufacturing an alkali-free glass substrate capable of manufacturing an alkali-free glass substrate having a higher strain point by decreasing the β-OH value of the glass is provided. The method for manufacturing an alkali-free glass substrate is a method for continuously manufacturing a SiO₂—Al₂O₃—RO (RO is one or more of MgO, CaO, BaO, SrO, and ZnO) based alkali-free glass substrate, which includes a step of preparing a raw material batch containing a tin compound and substantially not containing an arsenic compound or an antimony compound, a step of electric melting the prepared raw material batch in a melting furnace capable of conducting electric heating by a molybdenum electrode, and a step of forming the molten glass into a plate shape by a downdraw method.

### TECHNICAL FIELD

The present invention relates to a method for manufacturing an alkali-free glass substrate, and more particularly to a method for manufacturing an alkali-free glass substrate suitable for a display or the like including a thin film transistor (TFT) having a low temperature polysilicon (LTPS) film.

### BACKGROUND ART

In general, a glass substrate is used as a support substrate for a flat panel display. An electric circuit pattern such as a TFT is formed on the surface of the glass substrate. Therefore, an alkali-free glass substrate substantially free of alkali metal components is adopted for this type of glass substrate so as not to adversely affect the TFT or the like.

The glass substrate is exposed to a high temperature atmosphere in a step of forming an electric circuit pattern such as a thin film forming step or a thin film patterning step. When the glass substrate is exposed to a high temperature atmosphere, since a structural relaxation of the glass progresses, the volume of the glass substrate shrinks (hereinafter, the shrinkage of the glass is referred to as “thermal shrinkage”). When thermal shrinkage occurs in the glass substrate in the step of forming the electric circuit pattern, a shape dimension of the electric circuit pattern formed on the glass substrate deviates from the design value, it is difficult to obtain a flat panel display having desired electric performance. Therefore, it is desired that a glass substrate, such as a glass substrate for a flat panel display, on which a thin film pattern such as an electric circuit pattern is formed, has a small thermal shrinkage rate.

Particularly, in the case of a glass substrate for a high-definition display including a TFT having a low-temperature polysilicon film, when the low-temperature polysilicon film is formed, for example, the glass substrate is exposed to a very high temperature atmosphere of 450° C. to 600° C. and thermal shrinkage is likely to occur, it is difficult to obtain desired electric performance when heat shrinkage occurs since the electric circuit pattern has high definition. Therefore, it is strongly desired that the glass substrate used for such an application has a very low thermal shrinkage rate.

Meanwhile, as a method for forming a glass substrate used in a flat panel display or the like, a float method, a downdraw method represented by an overflow downdraw method, or the like is known.

The float method is a method of forming a glass substrate by allowing molten glass to flow out onto a float bath filled with molten tin and extend in the horizontal direction to form a glass ribbon, and then annealing the glass ribbon in an annealing furnace provided on the downstream side of the float bath. In the float method, since the conveyance direction of the glass ribbon is horizontal, it is easy to lengthen the annealing furnace. Therefore, it is easy to sufficiently lower the cooling speed of the glass ribbon in the annealing furnace. Thus, the float method has an advantage that a glass substrate having a small thermal shrinkage rate can be easily obtained.

However, in the float method, there is a disadvantage that it is difficult to form a thin glass substrate, and after the forming, the surface of the glass substrate must be polished to remove tin adhered to the surface of the glass substrate.

On the other hand, the downdraw method is a method in which the molten glass is stretched downward to form a plate. An overflow downdraw method, which is one type of downdraw method, is a method of forming a glass ribbon by stretching molten glass overflowing from both sides of a forming body having a substantially wedge-shaped cross section downward. Molten glass overflowing from both sides of the forming body flows down along both side surfaces of the forming body, and joins below the forming body. Therefore, in the overflow downdraw method, since the surface of the glass ribbon is formed by surface tension without being in contact with anything other than air, a glass substrate having a flat surface without adhering foreign matter can be obtained without polishing the surface after forming. In addition, according to the overflow downdraw method, there is an advantage that a thin glass substrate can be easily formed.

On the other hand, in the downdraw method, since the molten glass flows downward from the forming body, the forming body must be placed at a high place in order to dispose the long annealing furnace below the forming body. However, in practice, due to height restrictions of a ceiling of a factory or the like, there are restrictions on the height at which the forming body can be placed. That is, in the downdraw method, there is a restriction on a length dimension of the annealing furnace, and it may be difficult to dispose a sufficiently long annealing furnace. When the length of the annealing furnace is short, since the cooling speed of the glass ribbon is high, it is difficult to form a glass substrate having a small thermal shrinkage rate.

Therefore, it has been proposed to increase a strain point of the glass to decrease the thermal shrinkage rate of the glass. For example, Patent Document 1 discloses an alkali-free glass composition having a high strain point. The Patent Document 1 also describes that the lower the β-OH value representing the moisture content in the glass, the higher the strain point.

### PRIOR ART DOCUMENT

### Patent Document

Patent Document 1: JP-A-2013-151407

Patent document 2: JP-A-2011-020864

### SUMMARY OF INVENTION

### Problems to be Solved by Invention

As shown in FIG. 1, the effect of reducing the thermal shrinkage rate due to the increase in the strain point of the glass decreases as the strain point increases. Moreover, since the glass having a composition designed to have a high strain point has high viscosity, it is difficult to melt and form, and production efficiency is low. In addition, since the melting temperature and the forming temperature are high in such a glass, the burden on the manufacturing facility is heavy. Therefore, as disclosed in Patent Document 1, there is a limit to a method of decreasing the thermal shrinkage rate by adopting a high strain point composition. Although it is important to increase the strain point by decreasing the β-OH value, it is extremely difficult to greatly decrease the β-OH value of the glass when mass-produced on an industrial scale.

The present invention has been made in view of the above circumstances, and an object thereof is to provide a method for manufacturing an alkali-free glass substrate capable of manufacturing an alkali-free glass substrate having a higher strain point by decreasing the β-OH value of the glass.

### Means for Solving Problems

As a result of various studies, the present inventors have found that the amount of β-OH in the glass is greatly decreased by optimizing the raw material batch configuration, the melting method, or the like, and is proposed as the present invention.

That is, the method for manufacturing an alkali-free glass of the present invention, which is a method of continuously manufacturing a SiO₂—Al₂O₃—RO (RO is one or more of MgO, CaO, BaO, SrO, and ZnO) based alkali-free glass substrate, comprises a step of preparing a raw material batch containing a tin compound and substantially not containing an arsenic compound and an antimony compound, a step of electric melting the prepared raw material batch in a melting furnace capable of conducting electric heating by a molybdenum electrode, and a step of forming the molten glass into a plate shape by a downdraw method.

Here, the term “alkali-free glass” refers to a glass that is not intentionally added with an alkali metal oxide component, and specifically has a content of alkali metal oxide (Li₂O, Na₂O, and K₂O) in the glass composition of 2000 ppm (by mass) or less. The “continuously manufacturing” means to continuously manufacture glass for a certain period in a continuous melting furnace, such as a tank furnace. The “SiO₂—Al₂O₃—RO” refers to a glass composition containing SiO₂, Al₂O₃, and RO as essential components. The “electric melting” is a melting method in which electricity is supplied to the glass, and the glass is melted by Joule heat generated thereby. Here, a melting method that uses radiant heating by a heater or a burner as an auxiliary is not excluded. The “substantially free of arsenic and antimony” means that glass raw materials or glass cullet containing these components is not intentionally added to the glass batch. More specifically, in the obtained glass, arsenic is 50 ppm or less as As₂O₃, and antimony is 50 ppm or less as Sb₂O₃ on a molar basis. The “downdraw method” is a general term for a forming method in which the molten glass is formed while being continuously stretched downward.

Further, in the present invention, the glass is melted by using electric heating. It is possible to suppress an increase in moisture in the atmosphere by performing melting of the glass mainly by electric heating. As a result, it is possible to greatly suppress the moisture supply of the glass from the atmosphere, and it is easy to manufacture glass having a high strain point.

Further, in the present invention, a molybdenum electrode is adopted to perform electric heating. The molybdenum electrode has a high degree of freedom in arrangement and shape. Therefore, even an alkali-free glass which is difficult to conduct electricity can adopt an optimum electrode arrangement and an electrode shape, and electric heating is easy.

Further, the present invention is characterized in that a tin compound is contained as a fining agent, and an arsenic compound and an antimony compound are substantially free. Arsenic compounds and antimony compounds function as fining agents, but when these components are present in the glass, the molybdenum electrodes are significantly eroded, it is difficult to continuous manufacture glass on an industrial scale. On the other hand, tin does not erode the molybdenum electrode. Therefore, by adopting the above configuration, it is easy to manufacture glass without bubbles by electric heating.

Further, in the present invention, the glass is formed into a plate shape by a downdraw method. The downdraw method is a method of forming a molten glass in a plate shape while extending vertically downward, and it is difficult to sufficiently ensure an annealing time (distance) after forming since an annealing furnace is short as compared with a float method in which glass is drawn in a horizontal direction. That is, it is disadvantageous to obtain a glass having a small thermal shrinkage rate. Therefore, the advantage of reducing the moisture content to increase the strain point of the glass is remarkable.

In the present invention, it is desirable that radiation heating by burner combustion is not used in combination. The term “not using radiation heating by burner combustion” means not performing radiation heating by burner combustion during normal production, and does not exclude burner use at the time of production startup (when raising the temperature). Further, it is not excluded that radiation heating by a heater is used in combination at the time of production startup or during normal production. The time of production startup refers to a period until a raw material batch dissolves to be a glass melt and electric heating is possible.

By adopting the above configuration, the moisture content contained in the atmosphere in the melting furnace is extremely small, and the moisture supplied from the atmosphere into the glass can be greatly decreased. As a result, it is possible to manufacture glass with extremely low moisture content. In addition, equipment such as a burner, a flue, a fuel tank, a fuel supply path, and an air supply device (in the case of air combustion), an oxygen generator (in the case of oxygen combustion), an exhaust gas treatment device, and a dust collector necessary for combustion heating is unnecessary, or can be greatly simplified, so that the melting furnace can be made compact and the equipment cost can be reduced.

In the present invention, a chloride is preferably added to the raw material batch.

Chloride has the effect of decreasing moisture in the glass. When the moisture contained in the glass decreases, the strain point of the glass increases. Therefore, when the above configuration is adopted, it is easy to manufacture glass having a high strain point.

In the present invention, it is preferable not to add a raw material serving as a boron source to the raw material batch.

Since a glass raw material serving as a boron source is hygroscopic and may contain crystalline water, moisture is likely to be introduced into the glass. Therefore, if the above configuration is adopted, it is possible to further decrease the moisture content of the obtained glass. Since the boron component (B₂O₃) is a component that tends to decrease the strain point of the glass, a glass having a high strain point can be easily obtained by adopting the above configuration.

In the present invention, when the alkali-free glass substrate further containing B₂O₃ is manufactured as the glass composition, boric anhydride is preferably used for at least a part of the glass raw material serving as the boron source.

By adopting the above configuration, it is possible to further decrease the moisture content of the obtained glass. Further, since the boron component (B₂O₃) is a component that improves the meltability of the glass, if the above configuration is adopted, a glass excellent in productivity can be easily obtained.

In the present invention, the raw material batch preferably contains no hydroxide raw material.

By adopting the above configuration, it is possible to further decrease the moisture content of the obtained glass.

In the present invention, when a glass cullet is added to the raw material batch to manufacture an alkali-free glass substrate, it is preferable to use a glass cullet made of glass having a β-OH value of 0.4/mm or less in at least a part of the glass cullet. Here, the term “glass cullet” refers to defective glass produced during manufacture of glass, recycled glass collected from the market, or the like. The “β-OH value” refers to a value obtained by measuring the transmittance of glass using FT-IR and using the following formula.

β-OH value=(1/X) log (T1/T2)

X: glass thickness (mm)

T1: transmittance (%) at reference wavelength 3846 cm⁻¹

T2: minimum transmittance (%) near the hydroxyl group absorption wavelength 3600 cm⁻¹

Since an alkali-free glass has a high volume resistance, the alkali-free glass tends to be difficult to melt as compared with a glass containing an alkali. Therefore, when the above configuration is adopted, the glass can be easily melted, and the moisture content of the obtained glass can be further decreased.

In the present invention, it is preferable to adjust the glass raw material and/or the melting condition so that the β-OH value of the obtained glass is 0.2/mm or less.

By adopting the above configuration, it is easy to obtain a glass having a high strain point and high thermal shrinkage.

In the present invention, the strain point of the obtained glass is preferably 690° C. or more. Here, the “strain point” is a value measured based on the method of ASTM C336-71.

By adopting the above configuration, it is possible to obtain a glass having a very low thermal shrinkage rate.

In the present invention, it is preferable that the thermal shrinkage rate of the obtained glass is 25 ppm or less. Here, the “thermal shrinkage rate” is a value measured under a condition where the glass is heated at a rate of 5° C./min from room temperature to 500° C. and held at 500° C. for 1 hour, and then cooled at a rate of 5° C./min.

By adopting the above configuration, it is possible to obtain a glass substrate suitable for forming a low-temperature polysilicon TFT.

In the present invention, it is preferable to use a glass substrate on which a low-temperature polysilicon TFT is formed.

The low-temperature polysilicon TFT has a heat treatment temperature in the vicinity of 450° C. to 600° C. when formed on the substrate, and moreover, the circuit pattern is finer. Therefore, a glass substrate used for this type of application is required to have a particularly low thermal shrinkage rate. Therefore, the advantage of adopting the method of the present invention capable of producing a glass substrate having a significantly high strain point is remarkable.

### BRIEF DESCRIPTION OF DRAWINGS

FIG. 1 is a graph showing a relationship between a strain point and a thermal shrinkage rate of glass.

FIG. 2 is an explanatory diagram showing a schematic configuration of a glass manufacturing facility for carrying out the manufacturing method of the present invention.

FIG. 3 is a plane diagram for explaining a procedure of measuring the thermal shrinkage rate of the glass substrate.

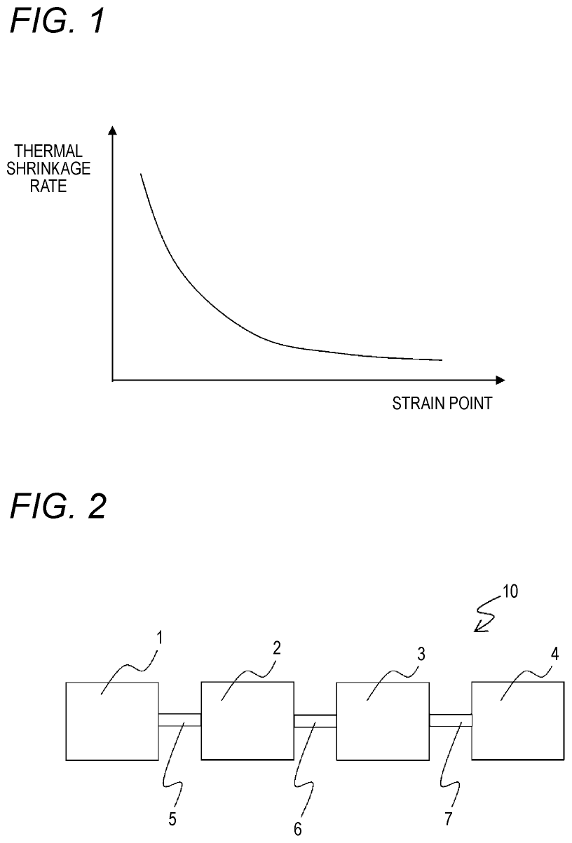

### DESCRIPTION OF EMBODIMENTS

A method for manufacturing an alkali-free glass of the present invention will be described in detail below.

The method of the present invention comprises a step of preparing a raw material batch, a step of electric melting the prepared batch, and a step of forming the molten glass into a plate shape.

(1) Step of Preparing Raw Material Batch

First, a glass raw material is prepared so as to be a alkali-free glass containing a composition of SiO₂—Al₂O₃—RO (RO is one or more of MgO, CaO, BaO, SrO and ZnO), more specifically, containing 50 mol % to 75 mol % of SiO₂, 5 mol % to 20 mol % of Al₂O₃, and 5 mol % to 30 mol % of RO. A preferable glass composition will be described later.

As the glass raw material, for example, silica sand (SiO₂) or the like can be used as the silicon source.

As the aluminum source, alumina (Al₂O₃), aluminum hydroxide (Al(OH)₃), or the like can be used. Since aluminum hydroxide contains crystal water, when the usage ratio is large, the moisture content of the glass is less likely to be decreased. Therefore, it is preferable that aluminum hydroxide is not used as much as possible. Specifically, the usage ratio of aluminum hydroxide is preferably 50% or less, 40% or less, 30% or less, 20% or less, or 10% or less, with respect to 100% of the aluminum source (in terms of Al₂O₃).

Examples of the alkaline earth metal source include calcium carbonate (CaCO₃), magnesium oxide (MgO), magnesium hydroxide (Mg(OH)₂), barium carbonate (BaCO₃), barium nitrate (Ba(NO₃)₂), strontium carbonate (SrCO₃), and strontium nitrate (Sr(NO₃)₂). Since magnesium hydroxide contains crystal water, when the usage ratio is large, the moisture content of the glass is less likely to be decreased. Therefore, magnesium hydroxide is preferably not used as much as possible. Specifically, magnesium hydroxide is preferably 50% or less, 40% or less, 30% or less, 20% or less, or 10% or less, with respect to 100% of the magnesium source (in terms of MgO), and preferably not used as much as possible.

Zinc oxide (ZnO) or the like can be used as the zinc source.

Further, in the present invention, it is preferable to contain chloride in a batch. The chloride functions as a dehydrating agent that greatly decreases the moisture content of the glass. In addition, there is an effect of promoting the action of a tin compound as a fining agent. Further, the chloride is decomposed and volatilized in a temperature range of 1200° C. or higher to generate a fining gas, and a formation of a heterogeneous layer is suppressed by the stirring effect. Chloride has an effect of capturing and dissolving silica raw materials such as silica sand at the time of decomposition thereof. As the chloride, for example, chlorides of alkaline earth metals such as strontium chloride, aluminum chloride, or the like can be used.

Further, in the present invention, a tin compound is contained in the batch. The tin compound functions as a fining agent. Further, there is a function of increasing the strain point or decreasing the high temperature viscosity. As the tin compound, for example, tin oxide (SnO₂) or the like can be used. When tin oxide is used, it is preferable to use tin oxide having an average particle diameter D₅₀ in the range of 0.3 μm to 50 μm. When the average particle diameter D₅₀ of the tin oxide powder is small, aggregation between particles occurs, and clogging in the mixing plant is likely to occur. On the other hand, when the average particle diameter D₅₀ of the tin oxide powder is large, the dissolution reaction of the tin oxide powder to the glass melt is delayed, and the fining of the melt does not proceed. As a result, the oxygen gas cannot be sufficiently released at an appropriate time of glass melting, and bubbles remain in the glass product, so that it is difficult to obtain a product having excellent bubble. In addition, in the glass product, it is easy to cause the occurrence of undissolved stone of SnO₂ crystals in glass product. A preferable range of the average particle diameter D₅₀ of the tin oxide powder is 2 μm to 50 μm, particularly 5 μm to 50 μm.

Further, in the present invention, it is preferable that a raw material serving as a boron source is not contained (in other words, B₂O₃ is not contained as a glass composition). That is, although orthoboric acid (H₃BO₃) or boric anhydride (B₂O₃) is known as the boron source, since these materials are hygroscopic, these materials introduce a large amount of moisture into the glass depending on the storage situation. In addition, since orthoboric acid contains crystal water, when the usage ratio is large, the moisture content of the glass is less likely to be decreased. In the case where B₂O₃ has to be contained as the glass composition, it is preferable to increase the usage ratio of the anhydrous boric acid as much as possible. Specifically, it is desirable that boric anhydride is 50% or more, 70% or more, 90% or more, and particularly the total amount, with respect to 100% of the boron source (in terms of B₂O₃).

Further, in the present invention, other than the above, various glass raw materials can be used depending on the glass composition. For example, zircon (ZrSiO₄) or the like may be used as the zirconia source, titanium oxide (TiO₂) or the like may be used as the titanium source, and aluminum metaphosphate (Al(PO₃)₃) or magnesium pyrophosphate (Mg2P₂O₇) may be used as the phosphate source.

It is important in the present invention to be substantially free of arsenic compounds and antimony compounds in a batch. When these components are contained, since the molybdenum electrode is eroded, it is difficult to stably electrically melt over a long period of time. These components are not preferable in terms of environment.

In the present invention, in addition to the above-described glass raw materials, glass cullet is preferably used. When the glass cullet is used, the usage ratio of the glass cullet to the total amount of the raw material batch is preferably 1 mass % or more, 5 mass % or more, and particularly preferably 10 mass % or more. The upper limit of the usage ratio of the glass cullet is not limited, but is preferably 50 mass % or less, 40 mass % or less, and particularly preferably 30 mass % or less. At least a part of the glass cullet to be used is preferably a low moisture glass cullet composed of glass having a β-OH value of 0.4/mm or less, 0.35/mm or less, 0.3/mm or less, 0.25/mm or less, 0.2/mm or less, and particularly 0.15/mm or less. The lower limit of the β-OH value of the low moisture glass cullet is not particularly limited, but is practically 0.01/mm or more.

The amount of the low moisture glass cullet to be used is preferably 50 mass % or more, 60 mass % or more, 70 mass % or more, 80 mass % or more, 90 mass % or more with respect to the total amount of the glass cullet used, and particularly all of the used glass cullet is preferably the low moisture glass cullet. When the β-OH value of the low moisture glass cullet is not sufficiently low or when the usage ratio of the low moisture glass cullet is small, the effect of decreasing the β-OH value of the obtained glass is reduced.

It should be noted that the glass raw material, the glass cullet, or the raw material batch prepared by mixing these materials may contain moisture. In addition, moisture in the atmosphere may be absorbed during storage. Therefore, in the present invention, it is preferable to introduce dry air into a raw material silo for weighing and supplying the individual glass raw materials, a pre-furnace silo for introducing the prepared raw material batch into the melting furnace, or the like.

(2) Step of Electric Melting Prepared Raw Material Batch

Next, the prepared raw material batch is fed into a melting furnace and subjected to electric melting.

The melting furnace has a plurality of molybdenum electrodes, and when electricity is applied between the molybdenum electrodes, electricity is supplied to the glass melt, and the glass is continuously melted by the Joule heat. In addition, radiation heating by a heater or a burner may be used in combination, but it is desirable to use a complete electric melting without using a burner from the viewpoint of decreasing the β-OH value of the glass. When the glass is heated by the burner, moisture generated by combustion is taken into the glass, so that it is difficult to sufficiently decrease the moisture content of the glass.

As described above, since the degree of freedom of the arrangement location and the electrode shape of the molybdenum electrode is high, even an alkali-free glass which is difficult to conduct electricity, it is possible to adopt an optimum electrode arrangement and an electrode shape, and to facilitate the electric heating. The electrode shape is preferably a rod shape. In the case of a rod shape, a desired number of electrodes can be arranged at an arbitrary position on the side wall surface or the bottom wall surface of the melting furnace while maintaining a desired distance between the electrodes. It is desirable that a plurality of pairs of electrodes are arranged on the wall surface (side wall surface, bottom wall surface, or the like) of the melting furnace, particularly on the bottom wall surface in a state where distance between the electrodes is shorten. When an arsenic component or an antimony component is contained in the glass, it is not possible to use a molybdenum electrode for the reason described above, and instead, it is necessary to use a tin electrode that is not eroded by these components. However, since the degree of freedom of the arrangement position and the electrode shape of the tin electrode is very low, it is difficult to electrically melt the alkali-free glass.

The raw material batch fed into the melting furnace is melted by electric heating and a glass melt (molten glass) is obtained. In this case, the chloride contained in the raw material batch is decomposed and volatilized to bring the moisture in the glass into the atmosphere, thereby decreasing the β-OH value of the glass. The tin compound contained in the raw material batch dissolves in the glass melt and acts as a fining agent. More specifically, the tin component releases oxygen bubbles during the temperature raising process. The discharged oxygen bubbles expand and float the bubbles contained in the glass melt and remove the bubbles from the glass. In the temperature decreasing process, the tin component absorbs oxygen bubbles, thereby eliminates bubbles remaining in the glass.

Although the glass melted in the melting furnace is supplied to the forming apparatus, a fining vessel, a stirring tank, a state adjusting tank, or the like may be disposed between the melting furnace and the forming apparatus, and then supplied to the forming apparatus after passing therethrough. In addition, in order to prevent contamination of the glass, it is preferable that at least the contact surface with the glass is made of platinum or a platinum alloy in the connection flow path connecting the melting furnace and the forming apparatus (or each tank provided therebetween).

(3) Step of Forming Molten Glass into Plate Shape

Next, the glass melted in the melting furnace is supplied to a forming apparatus, and is formed into a plate shape by a downdraw method.

As the downdraw method, it is preferable to adopt an overflow downdraw method. The overflow downdraw method is a method in which molten glass overflows from both sides of a gutter refractory having a wedge-shaped cross section, and the overflowing molten glass is joined at the lower end of the gutter refractory and is stretched downward to form the glass into a plate shape. In the overflow downdraw method, the surface to be the surface of the glass substrate is not in contact with the gutter refractory, and is formed in the state of the free surface. Therefore, a glass substrate having good surface quality without being polished can be manufactured at low cost, and the size of the glass can be easily increased and thickness of the glass can be easily decreased. The structure and material of the gutter refractory used in the overflow downdraw method are not particularly limited as long as the structure and material thereof can achieve desired dimensions and surface accuracy. A method of applying a force when the downward stretching is performed is not particularly limited. For example, a method may be adopted in which a heat-resistant roll having a sufficiently large width is rotated in a state of being in contact with glass, or a method of stretching a plurality of pairs of heat-resistant rolls in contact only in the vicinity of the end surface of the glass. In addition to the overflow downdraw method, for example, a slot down method or the like can be adopted.

The glass formed into a plate shape in this manner is cut into a predetermined size, subjected to various chemical or mechanical processing as necessary, and a glass substrate is obtained.

(4) Composition of Alkali-Free Glass

Examples of the composition of the alkali-free glass to which the manufacturing method of the present invention can be suitably applied include a glass containing 60 mol % to 75 mol % of SiO₂, 9.5 mol % to 17 mol % of Al₂O₃, 0 to 9 mol % of B₂O₃, 0 to 8 mol % of MgO, 0 to 15 mol % of CaO, 0 to 10 mol % of SrO, 0 to 10 mol % of BaO, 0.001 mol % to 1 mol % of SnO₂, 0 to 3 mol % of Cl, substantially not containing As₂O₃ and Sb₂O₃, and having a molar ratio (CaO+SrO+BaO)/Al₂O₃ of 0.5 to 1.0. The reasons for limiting the content of each component as described above are shown below. In the description of the content of each component, % display refers to mol %, unless otherwise specified.

SiO₂ is a component that forms a network of glass. The content of SiO₂ is preferably 60% to 75%, 62% to 75%, 63% to 75%, 64% to 75%, 64% to 74%, and particularly preferably 65% to 74%. When the content of SiO₂ is too small, the density is too high, and the acid resistance tends to decrease. On the other hand, when the content of SiO₂ is too large, high temperature viscosity is high and meltability tends to decrease, and in addition, devitrification crystals such as cristobalite are likely to be precipitated, and the liquidus temperature tends to rise.

Al₂O₃ is a component that forms a network of glass, and is a component that increases strain points and Young's modulus, and further suppresses a phase separation. The content of Al₂O₃ is preferably 9.5% to 17%, 9.5% to 16%, 9.5% to 15.5%, and particularly preferably 10% to 15%. When the content of Al₂O₃ is too small, the strain point and Young's modulus tend to decrease, and the glass tends to be phrase-separated. On the other hand, when the content of Al₂O₃ is too large, a devitrified crystal such as mullite or anorthite tends to precipitate, and the liquidus temperature tends to rise.

B₂O₃ is a component for enhancing meltability and enhancing devitrification resistance. The content of B₂O₃ is preferably 0 to 9%, 0 to 8.5%, 0 to 8%, 0 to 7.5%, and particularly preferably 0 to 7.5%. When the content of B₂O₃ is too small, meltability and devitrification resistance tend to decrease, and resistance to hydrofluoric acid-based chemical liquid tends to decrease. On the other hand, when the content of B₂O₃ is too large, the Young's modulus and the strain point tend to decrease. In addition, the moisture content is increased. In order to prioritize the increase in the strain point and the decrease of the moisture content, the content of B₂O₃ is preferably 0 to 3%, 0 to 2%, particularly preferably 0 to 1%, and is more preferably substantially free. The phrase “substantially free of B₂O₃” means that B₂O₃ is not intentionally added, that is, a raw material serving as a boron source is not added, and is not excluded when mixed as an impurity. More objectively, the content of B₂O₃ is 0.1% or less.

MgO is a component that decreases the high temperature viscosity and enhances meltability, and is a component that remarkably increases the Young's modulus in alkaline earth metal oxides. The content of MgO is preferably 0 to 8%, 0 to 7%, 0 to 6.7%, 0 to 6.4%, and particularly preferably 0 to 6%. When the content of MgO is too small, meltability and Young's modulus tend to decrease. On the other hand, when the content of MgO is too large, the devitrification resistance easily decreases, and the strain point tends to decrease.

CaO is a component that decreases the high temperature viscosity without decreasing the strain point and significantly enhances meltability. Among alkaline earth metal oxides, since the introduced raw material is relatively inexpensive, the raw material cost is reduced by the component. The content of CaO is preferably 0 to 10%, 2% to 15%, 2% to 14%, 2% to 13%, 2% to 12%, and particularly preferably 2% to 11%. When the content of CaO is too small, it is difficult to obtain the above effect. On the other hand, when the content of CaO is too large, the glass tends to devitrify, and the coefficient of thermal expansion tends to increase.

SrO is a component that suppresses phase separation and enhances devitrification resistance. Further, SrO is a component that decreases the high temperature viscosity without decreasing the strain point to increase the meltability and suppresses the rise in liquidus temperature. The content of SrO is preferably 0 to 10%, 0.1% to 10%, 0.1% to 9%, 0.1% to 8%, 0.1% to 7%, and particularly preferably 0.1% to 6%. When the content of SrO is too small, it is difficult to obtain the above effect. On the other hand, when the content of SrO is too large, a strontium silicate-based devitrified crystal is likely to be precipitated, and the devitrification resistance tends to decrease.

BaO is a component that remarkably enhances devitrification resistance. The content of BaO is preferably 0 to 10%, 0 to 7%, 0 to 6%, 0 to 5%, and particularly preferably 0.1% to 5%. When the content of BaO is too small, it is difficult to obtain the above effect. On the other hand, when the content of BaO is too large, the density is too high and the meltability tends to decrease. In addition, a devitrified crystal containing BaO tends to be precipitated, and the liquidus temperature tends to rise.

SnO₂ is a component having a good refining action in a high temperature region, a component that increases a strain point, and is a component that decreases a high temperature viscosity. In addition, there is an advantage that a molybdenum electrode is not eroded. The content of SnO₂ is preferably 0.001% to 1%, 0.001% to 0.5%, 0.001% to 0.3%, and particularly preferably 0.01% to 0.3%. When the content of SnO₂ is too large, a devitrified crystal of SnO₂ is easily precipitated, and precipitation of a devitrified crystal of ZrO₂ is easily promoted. When the content of SnO₂ is less than 0.001%, it is difficult to obtain the above effect.

Cl has a dehydration effect, that is, an effect of decreasing the moisture content in the glass. In addition, Cl has an effect of promoting a melting of the alkali-free glass, and when Cl is added, the melting temperature can be decreased, the action of the fining agent can be promoted, and as a result, the life of the glass manufacturing furnace can be prolonged while the melting cost is reduced. However, when the Cl content is too large, the strain point tends to decrease. Therefore, the content of Cl is preferably 0 to 3%, 0.001% to 3%, 0.001% to 2%, and particularly preferably 0.001% to 1%.

The As₂O₃ and Sb₂O₃ are substantially free. Specifically, it means that the content of each of As₂O₃ and Sb₂O₃ is 50 ppm or less. While these components are useful as fining agents, the components should not be used since the components erode the molybdenum electrode and make it difficult to electric melting on an industrial scale. It is also preferable not to be used from the environmental viewpoint.

A molar ratio (CaO+SrO+BaO)/Al₂O₃ is an important component ratio for achieving both high specific Young's modulus and high strain point and enhancing devitrification resistance. The molar ratio (CaO+SrO+BaO)/Al₂O₃ is 0.5 to 1.5, 0.5 to 1.3, preferably 0.5 to 1.2, 0.5 to 1.1, 0.6 to 1.1, and particularly preferably 0.7 to 1.1. When the molar ratio (CaO+SrO+BaO)/Al₂O₃ is too small, a devitrified crystal caused by mullite or alkaline earth easily precipitates, and devitrification resistance is significantly decreased. On the other hand, when the molar ratio (CaO+SrO+BaO)/Al₂O₃ increases, an alkaline earth aluminosilicate-based devitrified crystal such as cristobalite or anorthite tends to be precipitated, devitrification resistance tends to decrease and it difficult to increase the specific Young's modulus and the strain point.

Other than the above components, for example, the following components may be added as optional components. The total content of the other components other than the above components is preferably 10% or less, particularly preferably 5% or less, from the viewpoint of appropriately achieving the effects of the present invention.

ZnO is a component that enhances meltability. However, when a large amount of ZnO is contained, the glass tends to devitrify, and the strain point tends to decrease. The content of ZnO is preferably 0 to 5%, 0 to 4%, 0 to 3%, and particularly preferably 0 to 2%.

P₂O₅ is a component that increases the strain point, and is a component capable of suppressing precipitation of an alkaline earth aluminosilicate-based devitrified crystal such as anorthite. However, when a large amount of P₂O₅ is contained, the glass tends to be phase-separated. The content of P₂O₅ is preferably 0 to 2.5%, 0 to 1.5%, 0 to 1%, and particularly 0 to 0.5%.

TiO₂ is a component that decreases the high temperature viscosity to increase the meltability and suppresses solarization, but when a large amount of TiO₂ is contained, the glass is colored, and the transmittance tends to decrease. The content of TiO₂ is preferably 0 to 4%, 0 to 3%, 0 to 2%, particularly preferably 0 to 0.1%.

Y₂O₃ and Nb₂O₅ function to increase strain point, Young's modulus, or the like. However, when the content of these components is more than 2%, the density tends to increase.

La₂O₃ also functions to increase strain point, Young's modulus, or the like, but in recent years, the price of the introduced raw material has increased. The alkali-free glass of the present invention does not completely exclude La₂O₃, but is preferably not substantially added from the viewpoint of the batch cost. The content of La₂O₃ is preferably 2% or less, 1% or less, 0.5% or less, and substantially not contained (0.1% or less).

ZrO₂ has a function of increasing strain point and Young's modulus. However, when the content of ZrO₂ is too large, devitrification resistance is remarkably decreased. In particular, when SnO₂ is contained, it is necessary to strictly regulate the content of ZrO₂. The content of ZrO₂ is preferably 0.2% or less, 0.15% or less, and particularly preferably 0.1% or less.

(5) Properties of Alkali-Free Glass Substrate

Next, an alkali-free glass substrate obtained by the method of the present invention will be described.

The alkali-free glass substrate obtained by the method of the present invention preferably has a thermal shrinkage rate of 25 ppm or less, 20 ppm or less, 15 ppm or less, and particularly 10 ppm or less when the glass is heated at a rate of 5° C./min from room temperature to 500° C., held at 500° C. for 1 hour, and then cooled at a rate of 5° C./min. When the thermal shrinkage rate is large, it is difficult to use the alkali-free substrate as a substrate for forming a low-temperature polysilicon TFT.

The alkali-free glass substrate obtained by the method of the present invention is preferably made of glass having a β-OH value of 0.2/mm or less, 0.18/mm or less, 0.16/mm or less, and particularly 0.15/mm or less. The lower limit of the β-OH value is not limited, but is preferably 0.01/mm or more, and particularly preferably 0.05/mm or more. When the β-OH value is large, the strain point of the glass is not sufficiently high, and it is difficult to significantly decrease the thermal shrinkage rate.

The alkali-free glass obtained by the method of the present invention preferably has a strain point of more than 670° C., more than 675° C., more than 680° C., more than 685° C., more than 690° C., more than 700° C., more than 710° C., and particularly more than 720° C. This makes it easy to suppress thermal shrinkage of the glass substrate in the manufacturing steps of the low-temperature polysilicon TFT.

The alkali-free glass substrate obtained by the method of the present invention is preferably made of glass having a temperature corresponding to 10^{4.0} dPa·s of 1350° C. or less, 1345° C. or less, 1340° C. or less, 1335° C. or less, 1330° C. or less, and particularly 1325° C. or less. When the temperature at 10^{4.0} dPa·s is increased, the temperature during forming is too high, and the manufacturing cost of the glass substrate tends to increase. The “temperature corresponding to 10^{4.0} dPa·s” is a value measured by a platinum ball pulling method.

The alkali-free glass substrate obtained by the method of the present invention is preferably made of glass having a temperature at 10^{2.5} dPa·s of 1700° C. or less, 1695° C. or less, 1690° C. or less, particularly 1680° C. or less. When the temperature at 10^{2.5} dPa·s is increased, it is difficult to dissolve the glass, the manufacturing cost of the glass substrate is increased, and defects such as bubbles are likely to occur. The “temperature corresponding to 10^{2.5} dPa·s” is a value measured by the platinum ball pulling method.

The alkali-free glass obtained by the method of the present invention is preferably made of glass having liquidus temperature of less than 1300° C., 1290° C. or less, 1210° C. or less, 1200° C. or less, 1190° C. or less, 1180° C. or less, 1170° C. or less, 1160° C. or less, and particularly 1150° C. or less. This makes it easy to prevent an occurrence of a devitrified crystal at the time of manufacturing glass and decrease the productivity. Furthermore, since it is easy to form the glass substrate by the overflow downdraw method, the surface quality of the glass substrate can be easily enhanced, and the manufacturing cost of the glass substrate can be reduced. From the viewpoint of increasing the size of the glass substrate and the high definition of the display in recent years, it is very important to enhance the devitrification resistance in order to suppress the devitrification which may be a surface defect as much as possible. The liquidus temperature is an index of devitrification resistance, and the lower the liquidus temperature, the more excellent devitrification resistance. The “liquidus temperature” refers to a temperature at which a glass powder passing through a standard sieve 30 mesh (500 μm) and remaining in 50 meshes (300 μm) is held in a platinum boat and held in a temperature gradient furnace set at 1100° C. to 1350° C. for 24 hours, and then a platinum boat is taken out, and devitrification (crystal foreign matter) is observed in the glass.

The alkali-free glass substrate obtained by the method of the present invention is preferably made of glass having a viscosity of 10^{4.8} dPa˜s or more, 10^{4.9} dPa·s or more, 10^{5.0} dPa·s or more, 10^{5.1} dPa·s or more, 10^{5.2} dPa·s or more, 10^{5.3} dPa·s or more, and particularly 10^{5.4} dPa·s or more at the liquidus temperature. In this way, since devitrification hardly occurs at the time of forming, the glass substrate can be easily formed by the overflow downdraw method, and as a result, the surface quality of the glass substrate can be enhanced, and the manufacturing cost of the glass substrate can be reduced. The viscosity at the liquidus temperature is an index of formability, and the higher the viscosity at the liquidus temperature, the better the formability. The “viscosity at the liquidus temperature” refers to a viscosity of the glass at the liquidus temperature, and can be measured by, for example, the platinum ball pulling method.

### EXAMPLES

### Example 1

An embodiment of a manufacturing method of the present invention will be described below. FIG. 2 is an explanatory diagram showing a schematic configuration of a glass manufacturing facility 1 for carrying out the manufacturing method of the present invention.

First, a configuration of a glass manufacturing facility will be described. The glass manufacturing facility 10 includes a melting furnace 1 for electric melting a raw material batch, a fining tank 2 provided on a downstream side of the melting furnace 2, an adjusting tank 3 provided on the downstream side of the fining tank 2, a forming device 4 provided on a downstream side of the adjusting tank 3, and the melting furnace 1, the fining tank 2, the adjusting tank 3, and the forming device 4 are connected by communication channels 5, 6, and 7, respectively.

The melting furnace 1 has a bottom wall, a side wall, and a ceiling wall, and each of these walls is formed of a high zirconia-based refractory material such as ZrO₂ electroformed refractory or dense zircon. The side wall is designed to have a thin wall thickness to facilitate cooling of the refractory. A plurality of pairs of molybdenum electrodes are provided on the lower walls on both the left and right sides and on the bottom wall. The electrodes are respectively provided with cooling means so as not to excessively increase the electrode temperature. By applying electricity between the electrodes, the glass can be directly electrically heated. In the present embodiment, a burner used in normal production (except for a burner during production start-up) and a heater are not provided.

The side wall of the upstream side of the melting furnace 1 is provided with an inlet of a raw material supplied from a pre-furnace silo (not shown), and a downstream side wall is formed with an outlet, and the melting furnace 1 and the fining tank 2 communicate with each other via a narrow communication channel 5 having the outlet at the upstream end.

The fining tank 2 has a bottom wall, a side wall, and a ceiling wall, and each of these walls is formed of a high zirconia-based refractory. The communication channel 5 has a bottom wall, a side wall, and a ceiling wall, and each of these walls is also formed of a high zirconia-based refractory such as ZrO₂ electroformed refractory. The fining tank 2 is smaller in volume than the melting furnace 1, and the inner wall surfaces of the bottom wall and the side wall (at least the inner wall surface portion in contact with the molten glass) are lined with platinum or a platinum alloy, and the inner wall surfaces of the bottom wall and the side wall of the communication channel 5 are also lined with platinum or a platinum alloy. In the fining tank 2, the downstream end of the communication channel 5 is opened on the side wall on the upstream side. The fining tank 2 is a part where a refining of the glass is mainly performed, and fine bubbles contained in the glass are expanded and floated by a fining gas released from a fining agent, and are removed from the glass.

An outlet is formed in a side wall of the downstream side of the fining tank 2, and the adjusting tank 3 communicates with the downstream side of the fining tank 2 via a narrow communication channel 6 having an outlet at the upstream end.

The adjusting tank 3 has a bottom wall, a side wall, and a ceiling wall, and each of these walls is formed of a high zirconia-based refractory. The communication channel 6 has a bottom wall, a side wall, and a ceiling wall, and each of these walls is also formed of a high zirconia-based refractory such as ZrO₂ electroformed refractory. The inner wall surfaces of the bottom wall and the side wall of the adjusting tank 3 (at least the inner wall surface portion in contact with the molten glass) are lined with platinum or a platinum alloy, and the inner wall surfaces of the bottom wall and the side wall of the communication channel 7 are also lined with platinum or a platinum alloy. The adjusting tank 3 mainly adjusts the glass to a state suitable for forming, and gradually decreases the temperature of the molten glass to adjust the viscosity to a viscosity suitable for forming.

An outlet is formed in a side wall of the downstream side of the adjusting tank 3, and a forming device 4 communicates with the downstream side of the adjusting tank 3 via a narrow communication channel 7 having an outlet at the upstream end.

The forming device 4 is a downdraw forming device, and is, for example, an overflow downdraw forming device. The inner wall surfaces of the bottom wall and the side wall of the communication channel 7 are lined with platinum or a platinum alloy.

The supply path in the present embodiment refers to a path from the communication channel 5 provided downstream of the melting furnace to the communication channel 7 provided on the upstream side of the forming device. Although a glass manufacturing facility including each part of the melting furnace, the fining tank, the adjusting tank, and the forming device is exemplified, it is also possible to provide a stirring tank for stirring and homogenizing the glass between, for example, the adjusting tank and the forming device. Further, although each of the above-mentioned facilities has been shown in which the refractory is lined with platinum or a platinum alloy, it is needless to say that a facility composed of platinum or a platinum alloy itself may be used instead.

A method of manufacturing a glass using the glass manufacturing facility having the above configuration will be described.

First, a raw material batch is prepared so as to be SiO₂—Al₂O₃—(B₂O₃)—RO based alkali-free glass. For example, a raw material batch is prepared so as to have the composition shown in Table 1. In preparing the raw material batch, the raw material is appropriately selected such that positively use boric anhydride as the boron source, not use the raw material serving as the boron source, not use the hydroxide raw material, and positively use a glass cullet having a low β-OH value, and then the β-OH value of the obtained glass is low.

TABLE 1

| | a | b | c | d | e | f | g |
|---|---|---|---|---|---|---|---|
| SiO₂ | 66.1 | 69.3 | 72.9 | 70.6 | 71.5 | 69.5 | 72.8 |
| Al₂O₃ | 12.8 | 12.4 | 11.3 | 12.0 | 11.9 | 12.4 | 11.3 |
| B₂O₃ | 6.3 | 5.9 | 0.3 | 2.5 | 5.2 | 5.7 | 0.3 |
| MgO | 4.2 | 1.3 | 3.1 | 3.0 | 0.0 | 0.1 | 3.1 |
| CaO | 7.6 | 8.6 | 7.2 | 9.5 | 7.2 | 10.7 | 7.2 |
| SrO | 0.3 | 1.6 | 0.5 | 1.3 | 2.6 | 0.6 | 0.5 |
| BaO | 2.5 | 0.7 | 4.5 | 0.9 | 1.3 | 0.9 | 4.5 |
| SnO2 | 0.2 | 0.2 | 0.2 | 0.15 | 0.3 | 0.1 | 0.3 |
| Cl | 0.08 | 0.05 | 0.05 | 0.04 | 0.005 | 0.02 | 0.03 |

Subsequently, the mixed glass raw material is fed into the melting furnace 1 and melted and vitrified. In the melting furnace 1, a voltage is applied to the molybdenum electrode and the glass is directly electrically heated. In the present embodiment, since radiation heating by a burner combustion is not performed, an increase in moisture in the atmosphere does not occur, and a moisture content supplied from the atmosphere into the glass is significantly decreased. In the present embodiment, the glass raw material is heated by using a burner when the production is started, and the burner is stopped at the time when the first fed glass raw material is liquefied, and the flow proceeds to direct electric heating.

The molten glass vitrified in the melting furnace 1 is guided to the fining tank 2 through the communication channel 5. The molten glass contains a large number of bubbles generated during the vitrification reaction and contains a large number of trapped bubbles in the melt present between raw material particles, but in the fining tank 2, these bubbles are expanded and floated by the fining gas released from SnO₂, which is a fining agent component, and removed.

The molten glass fined in the fining tank 2 is guided to the adjusting tank through the communication channel 6. The molten glass guided to the adjusting tank 3 has a high temperature, has low viscosity, and cannot be formed as it is by a forming device. Therefore, the temperature of the glass is decreased in the adjusting tank and the glass is adjusted to have a viscosity suitable for forming.

The molten glass in which the viscosity is adjusted in the adjusting tank 3 is guided to the overflow downdraw forming device through the communication channel 7, and is formed into a thin plate shape. Further, a glass substrate made of the alkali-free glass can be obtained by cutting, end face processing, or the like.

According to the method described above, since the moisture supplied into the glass can be decreased as much as possible, the β-OH value can be set to 0.2/mm or less, and a glass having a small thermal shrinkage rate can be obtained.

### Example 2

Next, glass manufactured by using the method of the present invention will be described.

First, silica sand, aluminum oxide, orthoboric acid, boric anhydride, calcium carbonate, strontium nitrate, barium carbonate, tin oxide, strontium chloride, and barium chloride, and glass cullet of the above composition are mixed and formulated to be a composition with 66.1 mol % of SiO₂, 12.9 mol % of Al₂O₃, 6.0 mol % of B₂O₃, 3.8 mol % of MgO, 7.5 mol % of CaO, 1.0 mol % of SrO, 2.5 mol % of BaO, 0.1 mol % of SnO₂, 0.1 mol % of Cl. The ratio of boric anhydride to the boric acid raw material and the usage ratio of the glass cullet in the whole raw material are shown in Tables 2 and 3. The total mixing amount of alkali metal oxide components in the raw material was 0.01%.

The glass raw material was then fed into a melting furnace and melted, followed by fining and homogenizing the molten glass and adjusting to have a viscosity suitable for forming in the fining tank and the adjusting tank. The melting conditions were as shown in Tables 2 and 3. In the table, “electric” means electric heating by a molybdenum electrode, and “burner” means radiation heating by oxygen combustion using a burner.

Subsequently, the molten glass was supplied to the overflow downdraw forming device, formed into a plate shape, and then cut to obtain a glass sample having a thickness of 0.5 mm. The molten glass exiting the melting furnace was supplied to the forming device while being in contact with only platinum or a platinum alloy.

The β-OH value, the strain point of the glass, and the thermal shrinkage rate of the obtained glass sample were evaluated. Results thereof are shown in Tables 2 and 3.

TABLE 2

| | 1 | 2 | 3 | 4 |
|---|---|---|---|---|
| Usage ratio of boric | 10 | 50 | 100 | 100 |
| anhydride (%) | | | | |
| Cullet | | | | |
| Usage ratio (%) | 30 | 30 | 30 | 30 |
| β-OH value (/mm) | 0.135 | 0.135 | 0.135 | 0.550 |
| Melting conditions | | | | |
| Heating type | Electric | Electric | Electric | Electric |
| Maximum temperature | 1600 | 1600 | 1600 | 1600 |
| (° C.) | | | | |
| β-OH value (/mm) | 0.185 | 0.160 | 0.135 | 0.190 |
| Strain point (° C.) | 696 | 697 | 698 | 696 |
| Thermal shrinkage rate | 19.2 | 19.0 | 18.7 | 19.3 |
| (ppm) | | | | |

TABLE 3

| | 5 | 6 | 7 | 8 |
|---|---|---|---|---|
| Usage ratio of boric | 10 | 10 | 10 | 10 |
| anhydride (%) | | | | |
| Cullet | | | | |
| Usage ratio (%) | 30 | 60 | 35 | 35 |
| β-OH value (/mm) | 0.340 | 0.550 | 0.550 | 0.550 |
| Melting conditions | | | | |
| Heating type | Elec- | Elec- | Elec- | Burner |
| | tric + | tric + | tric + | |
| | burner | burner | burner | |
| Maximum temperature | 1600 | 1600 | 1600 | 1600 |
| (° C.) | | | | |
| β-OH value (/mm) | 0.340 | 0.420 | 0.390 | 0.450 |
| Strain point (° C.) | 689 | 685 | 686 | 683 |
| Thermal shrinkage rate | 22.1 | 25.7 | 24.0 | 26.4 |
| (ppm) | | | | |

The β-OH value of the glass was determined by measuring the transmittance of the glass using FT-IR and using the following formula.

β-OH value=(1/X) log (T₁/T₂)

X: glass thickness (mm)

T₁: transmittance (%) at reference wavelength 3846 cm⁻¹

T_{2:} minimum transmittance (%) near the hydroxyl group absorption wavelength 3600 cm⁻¹

Strain points were determined based on the method of ASTM C336-71.

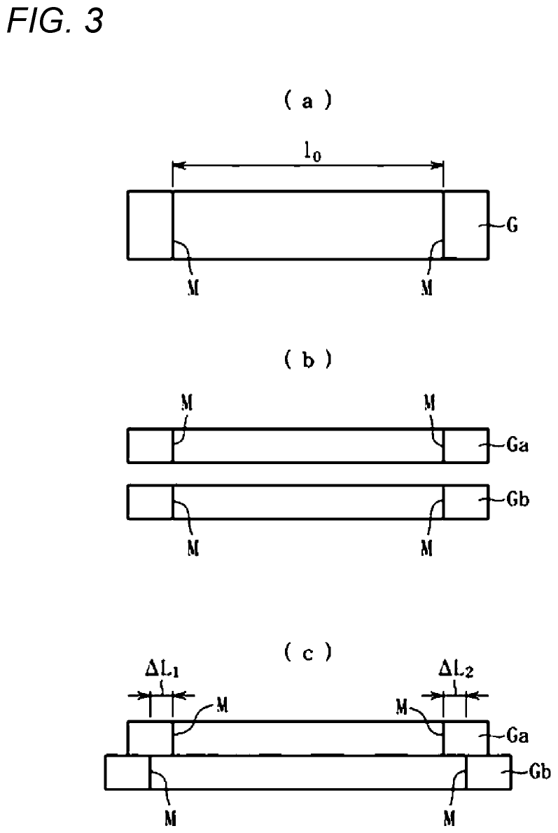

The thermal shrinkage rate was measured by the following method. First, as shown in FIG. 3(a), a strip sample G of 160 mm×30 mm is prepared as a sample of the glass substrate 1. The markings M are formed at each end portion in the long side direction of the strip sample G at a position of 20 mm to 40 mm from the edge by using #1000 waterproof abrasive paper. Thereafter, as shown in FIG. 3(b), the strip sample G on which the markings M are formed is divided by two in the direction orthogonal to the markings M to prepare the sample pieces Ga and Gb. Then, heat treatment is performed such that only one sample piece Gb is heated from room temperature to 500° C. at 5 ° C./min, held at 500° C. for 1 hour, and then cooled at 5° C./min. After the heat treatment, as shown in FIG. 3(c), in a state where the sample piece Ga not subjected to the heat treatment and the sample piece Gb subjected to the heat treatment are arranged in parallel, the positional deviation amounts (ΔL1, ΔL2) of the markings M of the two sample pieces Ga and Gb are read by a laser microscope, and the thermal shrinkage rate is calculated by the following formula. It should be noted that I₀ in the formula is the distance between the initial markings M.

Thermal shrinkage rate=[{ΔL₁(μm)+ΔL₂(μm)}×10³]/I₀(mm) (ppm)

### INDUSTRIAL APPLICABILITY

According to the method of the present invention, it is possible to easily obtain a glass substrate having a low thermal shrinkage ratio suitable for producing a low-temperature polysilicon TFT.

### DESCRIPTION OF REFERENCE NUMERALS

1 Melting furnace
2 Fining tank
3 Adjusting layer
4 Forming device
5, 6, 7 Communication channel
10 Glass manufacturing facility

1: A method for manufacturing an alkali-free glass substrate which is a method for continuously manufacturing a SiO₂—Al₂O₃—RO (RO is one or more of MgU, CaO, BaU, SrU, and ZnO) based alkali-free glass substrate comprising;
a step of preparing a raw material batch containing a tin compound and substantially not containing an arsenic compound or an antimony compound;
a step of electric melting the prepared raw material batch in a melting furnace capable of conducting electric heating by a molybdenum electrode; and
a step of forming the molten glass into a plate shape by a downdraw method.

2: The method for manufacturing an alkali-free glass substrate according to claim 1, wherein radiation heating by burner combustion is not used in combination.

3: The method for manufacturing an alkali-free glass substrate according to claim 1, wherein a chloride is added to the raw material batch.

4: The method for manufacturing an alkali-free glass substrate according to claim 1, wherein a raw material serving as a boron source is not added to the raw material batch.

5: The method for manufacturing an alkali-free glass substrate according to claim 1 which is a method for manufacturing the alkali-free glass substrate further containing B₂O₃ as a glass composition, wherein a boric anhydride is used for at least a part of a glass raw material serving as a boron source.

6: The method for manufacturing an alkali-free glass substrate according to claim 1, wherein the raw material batch does not contain a hydroxide raw material.

7: The method for manufacturing an alkali-free glass substrate according to claim 1, which is a method for manufacturing the alkali-free glass substrate by adding a glass cullet to the raw material batch, wherein a glass cullet made of glass having a β-OH value of 0.4/mm or less is used in at least a part of the glass cullet.

8: The method for manufacturing an alkali-free glass substrate according to claim 1, wherein the glass raw material and/or the melting condition are adjusted so that the obtained glass has a β-OH value of 0.2/mm or less.

9: The method for manufacturing an alkali-free glass substrate according to claim 1, wherein a strain point of the obtained glass is higher than 690° C.

10: The method for manufacturing an alkali-free glass according to claim 1, wherein the obtained glass has a thermal shrinkage rate of 25 ppm or less.

11: The method for manufacturing an alkali-free glass substrate according to claim 1, wherein the method is used for manufacturing a glass substrate on which a low-temperature p-Si TFT is formed.
